(19) United States
(12) Patent Application Publication
(10) Pub. No.: US 2023/0255196 A1
(43) Pub. Date: Aug. 17, 2023

(54) PRILLED LIME COMPOSITIONS, AND ASSOCIATED SYSTEMS AND METHODS

(71) Applicant: Graymont (NZ) Limited, Hamilton (NZ)

(72) Inventors: Narain Hariharan, South Jordan, UT (US); Ian Cook, Cambridge (NZ); Michael John Tate, Oregon, OH (US)

(21) Appl. No.: 18/169,789

(22) Filed: Feb. 15, 2023

Related U.S. Application Data
(60) Provisional application No. 63/310,959, filed on Feb. 16, 2022.

(51) Int. Cl. A01N 3/00; A01N 65/44; A01N 59/06; A01N 25/02

(52) U.S. Cl. CPC A01N 3/00; A01N 65/44; A01N 59/06; A01N 25/02; A01N 2300/00

(57) ABSTRACT

Prilled lime compositions and associated systems and methods are disclosed herein. In some embodiments, the prilled lime composition comprises 1-10% by weight of a binder; 45-75% by weight calcium hydroxide; no more than 30% magnesium oxide; and 1-10% water. The binder can include molasses, sodium lignosulfonate, calcium lignosulfonate, starch, sodium silicate, or bentonite.

### CROSS-REFERENCE TO RELATED APPLICATIONS

The present application claims the benefit of U.S. Provisional Patent Application No. 63/310,959, filed Feb. 16, 2022, the disclosure of which is incorporated herein by reference in its entirety.

### TECHNICAL FIELD

This present disclosure relates to prilled lime compositions, and associated systems and methods.

### BACKGROUND

Current products offered for use in the agricultural industry, such as granulated lime and limestone products, provide micronutrients (e.g., magnesium or sulphur) for soil and functional benefits including fugitive dust control and limited prevention of pH sensitive root diseases. However, such products have low acid neutralizing capacity and/or neutralizing value (NV), a relatively low pH when dissolved in water, and/or structural limitations that limit their long-term effect. As a result, these products require frequent application and their benefits brief, making their use economically difficult or in some cases unfeasible. Additionally, due to the relatively low NV, use of such products enables only marginal improvements in the desired outcomes, such as increased crop yield. In view of these and other deficiencies, there exists a need for an improved prilled product.

### BRIEF DESCRIPTION OF THE DRAWINGS

Features, aspects, and advantages of the presently disclosed technology may be better understood with regard to the following drawings.

FIGS. 1 and 2 are schematic cross-sectional illustrations of individual particles 100, 200 of a prilled lime composition, in accordance with embodiments of the present technology.

FIGS. 3 and 4 are flow diagrams of methods for producing prilled lime product compositions, in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present disclosure relate to low-dust prilled lime compositions for use in agricultural and other applications. Current products offered for use in the agricultural industry provide micronutrients (e.g., magnesium or sulphur) for soil and functional benefits including fugitive dust control and limited prevention of pH sensitive root diseases. However, such products have low acid neutralizing capacity and/or neutralizing value (NV), a relatively low pH when dissolved in water, and/or structural limitations that limit their long-term effect, all of which makes their use economically difficult or in some cases unfeasible.

Embodiments of the present disclosure address at least some of the above-described issues associated with current products. For example, as described herein, embodiments of the present disclosure can comprise compositions including lime and/or limestone, and that have both a relatively high NV and pH such that the beneficial effects of the compositions are more effective and realized for longer periods of time. The higher NV of such embodiments can also lower the frequency of application of the compositions, increase crop yield, and affect other changes that have economic benefits for the end user. In addition to the relatively high NV and pH, embodiments of the present technology can also have a predetermined minimum crush strength that enables low-dust application of the compositions, as well as a predetermined minimum solubility that enables nutrients of the composition to be dispersed gradually over time upon application. One such composition includes a combination of calcium carbonate (CaCO₃), one or more binders (e.g., molasses), lime (i.e., calcium hydroxide (Ca(OH)₂)), magnesium oxide (MgO), and/or water (H₂O). Another such composition includes a combination of calcium carbonate (CaCO₃), one or more binders, lime, magnesium oxide (MgO), quicklime or calcium oxide (CaO), and/or water (H₂O). Additional details of these and other embodiments are described below.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Prilled Lime Compositions, and Associated Systems and Methods

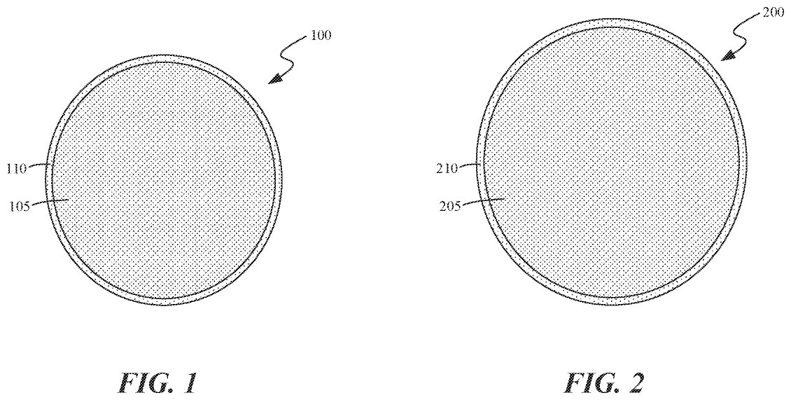

FIGS. 1 and 2 are schematic cross-sectional illustrations of individual particles 100,200 of a prilled lime composition, in accordance with embodiments of the present technology. Descriptions herein of the particles 100,200 can also correspond to the corresponding composition, which comprises a plurality of the respective particles 100, 200. Referring first to FIG. 1, the particle 100 includes a core 105 and an outer surface 110 peripheral to or radially outward of the core 105. The outer surface 110 can be hard and/or harder than the core 105, and can enable the relatively slow release over time of the chemical constituents of the core 105 and particle 100 generally.

The particle 100 can comprise a combination or blended mixture of calcium carbonate (CaCO₃), one or more binders, lime, magnesium oxide (MgO), and/or water (H₂O). For example, the particle 100 can comprise: (i) 70-95%, 75-90%, 80-90%, or 85-90% calcium carbonate, (ii) 1-10%, 2-8%, 3-7% of the one or more binders, (iii) 0-7%, 2-6%, 3-5% lime, (iv) 0-8%, 2-6%, 3-5% magnesium oxide, and/or (v) 1-10%, 1-6%, 1-5%, 2-5% water. These and other percentages listed herein are weight percentages of the particle 100 or composition. The one or more binders can include molasses, sodium lignosulfonate, calcium lignosulfonate, starch, sodium silicate, or bentonite. The lime can comprise hydrated lime and/or enhanced hydrated lime, which has a specific surface area of at least 20 m²/g, 25 m²/g, 30 m²/g, 35 m²/g, or 40 m²/g. The limestone can comprise pulverized limestone. In some embodiments, the particle 100 does not include all of the components listed above and/or one or more of the above chemical constituents is omitted. For example, the particle 100 may only include calcium carbonate, one or more binders, water and one of magnesium oxide or lime. In such embodiments, the particle 100 can comprise 75-90% calcium carbonate, 3-7% molasses, 3-5% lime, and 2-5% water.

Without being bound by theory, each chemical constituent and/or the combination of certain chemical constituents can provide or contribute to a unique functional benefit of the particle 100 for one or more end use applications. For example, the lime can (i) increase the acid-neutralizing capacity of the particle 100, e.g., to be above that achievable via limestone alone, (ii) enable the particle 100 to have a faster and/or higher pH lift to the soil the particle 100 is applied over, as well as have a crush strength above a predetermined threshold that allows the particle 100, e.g., to maintain its structure during application of the particle 100 (e.g., via truck or aircraft), and/or (iii) enhance the availability and reactivity of soluble calcium for interactions with the soil minerals, which in turn can impact the properties of the soil, e.g., by lowering the plasticity index, and/or increasing the compressive strength and soil stiffness. In this regard, a calcium carbonate based prill that does not include calcium hydroxide will not provide these benefits, and as a result can be less effective for use in the agricultural industry than embodiments of the present technology that comprise lime. As another example, the molasses can act as a binder for the chemical constituents of the particle 100. For instance, the molasses or other binder(s) can bind the limestone and water, therein (i) optimizing dispersion of the chemical constituents of the particle 100 over time, and (ii) reducing or removing the proportion of crushed limestone that could become entrained in the air during application of the particle 100. The molasses or other binder(s) can also provide a surface for other chemical constituents to adhere to and form the prill. Moreover, the molasses will also dissolve readily upon contact with water and release the active ingredients to the soil. As another example of the benefits of chemical constituents of the particle 100, the magnesium oxide can (i) provide magnesium nutrients, (ii) lower the need for molasses and/or other binders, (iii) provide additional crush strength to the particle 100 via formation of brucite, and/or (iv) further increase the acid-neutralizing potential of the particle 100, e.g., above that achieved with just lime.

Other factors of the particle 100 can vary based on the desired end use application. For example, the pH of the particle can be at least 9.5, 10.0, 10.5, 11.0, 11.5, or within a range of 9.5-11.5, 10-11.5, or 10.0-11.0. The NV of the particle 100 can be at least 90, 95, 100, 105, 110, 115, or within a range of 90-115, 95-110, or 100-110. The diameter of the particle 100 (or average diameter of the composition including the particles 100) can be at least 1 millimeter (mm), 2 mm, 3 mm, 4 mm, 5 mm, 6 mm, or within a range of 1-6 mm, 2-6 mm, or 2-5 mm. In some embodiments, the diameter of the particle 100 is no more than 3 mm, 2 mm, or 1 mm, such that the particles 100 can be injected via seed application equipment, which has a maximum allowed diameter. The crush strength of the particle 100 measured after 28 days (or the average crush strength of the composition including the particles 100 measured after 28 days) can be at least 1 kilogram (kg), 2 kg, 3 kg, 4 kg, 5 kg, 6 kg, or within a range of 1-6 kg, 2-6 kg, or 2-5 kg. Additionally or alternatively, the crush strength of the particle 100 can increase over time, such that the crush strength at the 28 day mark is greater than the crush strength at the 0 day mark. It is worth noting that the increase in crush strength can correlate to a decrease in solubility. As such, crush strength and solubility of the particles 100 may be chosen based on the desired end application. Crush strength can be determined using tablet hardness testers, including those manufactured by Erweka GmbH. Additionally or alternatively, the abrasion resistance of the particle 100 can be no more than 10.0%, 9.5%, 9.0%, 8.5%, 8.0%, 7.5%, 7.0%, 6.5%, or 6.5-10.0%. Abrasion resistance can be a measure of decay of the particles, with lower numbers indicating a higher strength particle. Abrasion resistance can be measured according to methods specific to—fertilizers (e.g., Incitic Method QLM-07-341), including rotary drum methods. Additionally or alternatively, the particle 100 can include a particle size distribution such that (i) no more than 5% of the composition is retained via a 6.7 millimeter (mm) screen (e.g., a first screen), (ii) 80-90% of the composition is retained via a 2.36 mm screen (e.g., a second screen finer than the first screen), and (iii) 5-8% of the composition is retained via a 500 micrometer screen (e.g., a third screen finer than the second screen).

NV or neutralizing capacity of the particle 100 (and particle 200 discussed herein) can be determined based on a percentage of calcium carbonate equivalence (CCE) on a dry basis. For example, one method for determining the NV or % CCE on a dry basis is the following:
1. Dry the sample (e.g., the particle 100, 200) and grind the dried sample to pass a US #100 sieve.
2. Weigh approximately 2.5 grams (g) of the ground sample and record to the nearest 0.001 g.
3. Combine the weighed sample and 100 ml of (1.000 N) HCl in a beaker.
4. Cover the beaker and bring to a boil, maintaining the boil for 5 minutes.
5. Stir the sample via a stir bar and position a pH-electrode to measure pH of the sample.
6. Titrate with (0.5 N) NaOH to bring the pH to 5.0, then continue until the pH reaches 7.0 and remains constant for 1 minute.
7. Note the volume of (0.5 N) NaOH used in the titration.

8. Calculate percent CCE on a dry basis:

$$\% {CaCO}_{3} = \frac{5.0 \; 045 x ( {V}_{1} {N}_{1} - {V}_{2} {N}_{2} )}{W} ;$$

wherein

V₁=volume of HCl standard solution in milliliters (mL)

N₁=normality of HCl standard solution

V₂=volume of NaOH standard solution necessary to titrate the excess acid (in mL)

N₂=normality of the NaOH standard solution

W=weight of the test sample (in grams)

The particles 100 can have many applications within the agriculture industry. For example, the particles 100 can be used to (i) ameliorate surficial and/or deep-rooted soil activity, (ii) ameliorate soil sodicity, e.g., due to cation exchange of the sodium and/or calcium of the particle 100, (iii) inhibit or prevent fugitive dust emitted during spreading of the particles 100 and/or soil amendment, (iv) promote mitigation of soil and crop diseases (e.g., club root), (v) increase crop yield, e.g., due to higher NV, and (vi) reduce greenhouse gas emissions footprint, which is due to the reduction in soil tillage, the increase in crop yield, the reduced need to rotate crops, and the reduced frequency of application of the particles 100.

Advantageously, embodiments of the particle 100 have multiple benefits and/or improvements over related products that currently exist. For example, the NV or acid-neutralizing ability of the particle 100, and the duration of the acid-neutralization, is greater than that of current products. As a result, the particle 100 can be more effective at promoting mitigation of soil and crop diseases and increasing crop yield, amongst other benefits. Additionally or alternatively, the structural configuration (e.g., the hard shell and soft core) and/or chemical constituents of the particle 100 can enable to the particle 100 to more slowly degrade and release its chemical constituents, thereby enabling the effects of the particle 100 to last longer and the application of the product to be less frequent.

Referring next to FIG. 2, the particle 200 includes a core 205 and an outer surface 210 peripheral to and radially outward of the core 205. The outer surface 210 can be hard and/or harder than the core 205, which can enable the relatively slow release over time of the chemical constituents of the core 205 and particle 200 generally. The particle 200 can comprise a combination of calcium carbonate (CaCO₃), one or more binders, lime or calcium hydroxide (Ca(OH)₂), magnesium oxide (MgO), quicklime or calcium oxide (CaO), and/or water (H₂O). For example, the particle 100 can comprise: (i) 0-75%, 0-50%, 0-25%, 0-20%, or 0-15% calcium carbonate, (ii) 1-10%, 2-10%, or 3-7% of the one or more binders, (iii) at least 10%, 20%, 30%, 40%, or 50% lime, or 45-75%, 50-70%, or 60-70% lime, (iv) 0-30%, 5-30%, 15-30% magnesium oxide, (v) 0-25%, 0-20%, or 10-20% quicklime, and/or (vi) 1-10%, 2-10%, 5-10% water. The binder can include one or more of sodium lignosulfonate, calcium lignosulfonate, starch, molasses, sodium silicate, or bentonite. The lime can comprise hydrated lime and/or enhanced hydrated lime, and the limestone can comprise pulverized limestone. In some embodiments, one or more of the above chemical constituents is omitted. For example, quicklime and/or calcium carbonate may be omitted from the particle 200. In such embodiments, the particle 200 can comprise 50-70% lime, 15-30% magnesium oxide, 3-7% binder, and 5-10% water.

Without being bound by theory, each chemical constituent and/or the combination of certain chemical constituents can provide or contribute to a unique functional benefit of the particle 200 for one or more end use applications. For example, the lime can (i) increase the acid-neutralizing capacity of the particle 200, e.g., to be above that achievable via limestone alone, (ii) enable the particle 200 to have a faster and/or higher pH lift to the soil the particle is applied over, as well as have a crush strength above a predetermined threshold that allows the particle 200 to maintain its structure during application of the particle 200, and/or (iii) enhance the availability and reactivity of soluble calcium for interactions with the soil minerals, which in turn can impact the properties of the soil, e.g., by lowering the plasticity index, and/or increasing the compressive strength and soil stiffness. As described elsewhere herein, a calcium carbonate based prill that does not include calcium hydroxide will not provide these benefits, and as a result can be less effective for use in the agricultural industry than embodiments of the present technology that comprise lime. As another example, the binder can bind the various chemical constituents to ensure a more uniform distribution of the chemical constituents within the particle 200 and/or reduce or remove the proportion of certain chemical constituents (e.g., lime and/or limestone) that could become entrained in the air during application of the particle 200. As another example of the benefits of chemical constituents of the particle 200, the magnesium oxide can (i) provide magnesium nutrients, e.g., for plant growth, (ii) lower the need for molasses and/or other binders, (iii) provide additional crush strength to the particle 100 via formation of brucite, and/or (iv) further increase the acid-neutralizing potential of the particle 100, e.g., above that achieved with just lime. Additionally or alternatively, the binder can aid water ingress into the particle 200, and thereby increase solubility.

Other factors of the particle 200 can vary based on the desired end use application. For example, the pH of the particle can be at least 10.0, 10.5, 11.0, 11.5, 12.0, 12.5 or within a range of 10.0-12.5, 11.0-12.5, or 11.5-12.5. The NV of the particle 100 can be at least 100, 110, 120, 130, 140, 150, or within a range of 100-150, 110-150, or 120-150. The diameter of the particle 200 (or average diameter of the composition including the particles 200) can be at least 1 mm, 2 mm, 3 mm, 4 mm, 5 mm, 6 mm, or within a range of 1-6 mm, 2-6 mm, or 2-5 mm. In some embodiments, the diameter of the particle 200 is no more than 3 mm, 2 mm, or 1 mm, such that the particles 200 can be injected via seed application equipment, which has a maximum allowed diameter. The crush strength of the particle 200 measured after 28 days (or the average crush strength of the composition including the particles 200 measured after 28 days) can be at least 1 kg, 2 kg, 3 kg, 4 kg, 5 kg, 6 kg, 7 kg or within a range of 1-7 kg, 2-6 kg, or 3-6 kg. Additionally or alternatively, the crush strength of the particle 200 can increase over time, such that the crush strength at the 28 day mark is greater than the crush strength at the 0 day mark. Additionally or alternatively, the abrasion resistance of the particle 200 can be no more than 10.0%, 9.5%, 9.0%, 8.5%, 8.0%, 7.5%, 7.0%, 6.5%, or 6.5-10.0%. Abrasion resistance can be a measure of decay of the particles, with lower numbers indicating a higher strength particle. Additionally or alternatively, the particle 200 can include a particle size distribution such that (i) no more than 5% of the composition is retained via a 6.7 millimeter (mm) screen (e.g., a first screen), (ii) 80-90% of the composition is retained via a 2.36 mm screen (e.g., a second screen finer than the first screen), and (iii) 5-8% of the composition is retained via a 500 micrometer screen (e.g., a third screen finer than the second screen).

The particles 200 can have many applications within the agriculture industry, including those listed previously with respect to particle 100 and FIG. 1. For example, the particles 200 can be used to (i) ameliorate surficial and/or deep-rooted soil activity, (ii) ameliorate soil sodicity, e.g., due to cation exchange of the sodium and/or calcium of the particle 200, (iii) inhibit or prevent fugitive dust emitted during spreading of the particles 100 and/or soil amendment, (iv) promote mitigation of soil and crop diseases (e.g., club root), (v) increase crop yield, e.g., due to higher NV, and (vi) reduce greenhouse gas emissions footprint, e.g., due to the reduction in soil tillage, the increase in crop yield, and the reduced frequency of application of the particles 200.

Advantageously, embodiments of the particle 200 have multiple benefits and/or improvements over related products that currently exist. For example, the NV or acid-neutralizing ability of the particle 200, and the duration of the acid-neutralization, is greater than that of current products. As a result, the particle 200 can be more effective at promoting mitigation of soil and crop diseases and increasing crop yield, amongst other benefits. Additionally or alternative, the structural configuration (e.g., the hard shell and soft core) and/or chemical constituents of the particle 200 can enable to the particle 200 to more slowly degrade and release its chemical constituents, thereby enabling the effects of the particle 100 to last longer and the application of the product to be less frequent.

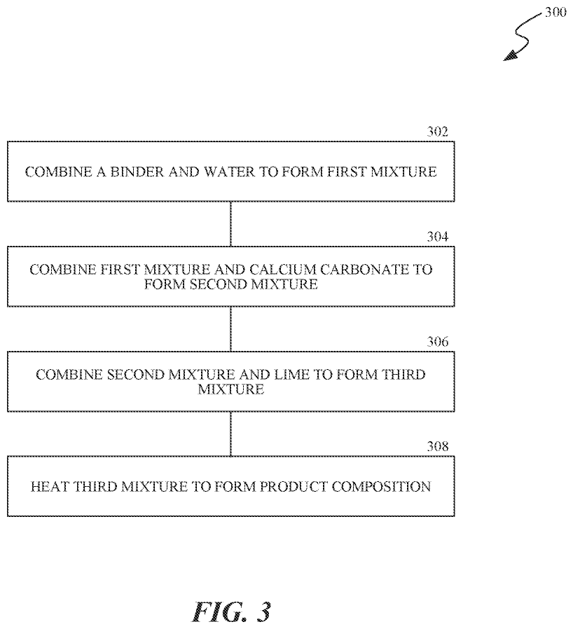

FIG. 3 is a flow diagram of a method 300 for producing a prilled lime product composition, in accordance with embodiments of the present technology. The product composition described with reference to FIG. 3 can correspond to a plurality of the particles 100 (FIG. 1). The method 300 can include combining water and a binder to form a first mixture (process portion 302). The binder can comprise molasses, sodium lignosulfonate, calcium lignosulfonate, starch, sodium silicate, or bentonite. The weight ratio of the binder to water can be within a range of 90:10 to 50:50. For example, when the binder is molasses, the weight ratio can comprise 90%, 80%, 70%, 60%, or 50% molasses, with the balance being water. Diluting the binder decreases viscosity and enables more uniform distribution of the binder within the end product composition.

The method 300 further comprises combining the first mixture and calcium carbonate to form a second mixture (process portion 304). The calcium carbonate or limestone is preferably combined with the binder (e.g., molasses) after the dilution of the binder, such that the decreased viscosity of the diluted binder has more or maximum contact with the calcium carbonate. This can enable the binder to bind more calcium carbonate particles and therein reduce and/or remove the proportion of calcium carbonate particles that could become entrained in the air during application of the composition or end product. In some embodiments, at least 60%, 70%, or 80% of the second mixture has a particles size no more than 0.20 mm, 0.15 mm, or 0.10 mm.

The method 300 further comprises combining the second mixture with magnesium oxide and/or lime to form a third mixture (process portion 306). In some embodiments, lime and/or magnesium oxide can cause the molasses and/or other binders to set. As such, to improve binding efficiency of the composition, the lime is preferably added to the mixture after calcium carbonate is added. In some embodiments, the magnesium oxide is pre-hydrated, e.g., by being soaked in water for up to 12 hours to form a slurry. The lime and second mixture can be blended at a relatively low rotational speed (e.g., less than 20 revolutions per minute (rpm), 30 rpm, or 40 rpm) for a predetermined amount of time (e.g., 5 minutes or 10 minutes). The relatively low rotational speed can help control particle size distribution of the composition. Additionally or alternatively, blending the third mixture at a higher speed can undesirably affect the structure of the particle and/or cause the particle to crack or break, thereby limiting its intended functional benefits. In some embodiments, water is sprayed over the third mixture to promote granulation thereof.

The method 300 further comprises heating the third mixture to form a product composition (process portion 308). In some embodiments, the third mixture is heated up to at least a predetermined temperature (e.g., 50° C., 55° C., or 60° C.) for a predetermined amount of time (e.g., 12 hours or 24 hours) until the product composition (e.g., a plurality of the particles 100 or the particles 200) is sufficiently dry (e.g., moisture content less than 0.1%) and/or hardened. As described herein, the product composition can correspond to the particle 100 (FIG. 1) and thus can comprise: (i) 70-95%, 75-90%, 80-90%, or 85-90% calcium carbonate, (ii) 1-10%, 2-8%, 3-7% molasses, (iii) 1-7%, 2-6%, 3-5% lime, (iv) 0-8%, 2-6%, 3-5% magnesium oxide, and/or (v) 1-6%, 1-5%, 2-5% water. Additionally or alternatively, (i) the pH of the particle can be at least 9.5, 10.0, 10.5, 11.0, 11.5, or within a range of 9.5-11.5, 10-11.5, or 10.0-11.0, (ii) the NV of the particle 100 can be at least 90, 95, 100, 105, 110, 115, or within a range of 90-115, 95-110, or 100-110, (iii) the diameter of the particle 100 (or average diameter of the composition including the particles 100) can be at least 1 millimeters (mm), 2 mm, 3 mm, 4 mm, 5 mm, 6 mm, or within a range of 1-6 mm, 2-6 mm, or 2-5 mm, and (iv) the crush strength of the particle 100 measured after 28 days (or the average crush strength of the composition including the particles 100 measured after 28 days) can be at least 1 kilogram (kg), 2 kg, 3 kg, 4 kg, 5 kg, 6 kg, or within a range of 1-6 kg, 2-6 kg, or 2-5 kg.

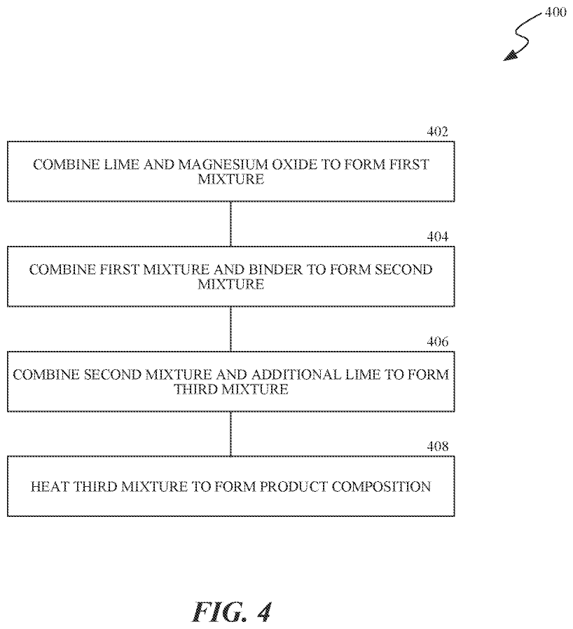

FIG. 4 is a flow diagram of a method 400 for producing a prilled lime product composition, in accordance with embodiments of the present technology. The product composition described with reference to FIG. 4 can correspond to a plurality of the particles 200 (FIG. 2). The method 400 can include combining lime and magnesium oxide to form a first mixture (process portion 402). The weight ratio of lime to magnesium oxide can be 10:90 to 90:10. That is, the weight ratio can comprise 10%, 20%, 30%, 40%, 50%, 60%, 70%, 80%, or 90% lime, with the balance being magnesium oxide. Combining lime and magnesium oxide first in the process of producing the composition (e.g., prior to adding binders, additional lime, etc.) can enable water to be utilized or better utilized as an essential binder throughout the method 400. Additionally or alternatively, combining lime and magnesium oxide first can initiate hydration of magnesium oxide, which can help regulate the solubility of the composition or end product.

The method 400 further comprises combining the first mixture and a binder to form a second mixture (process portion 404). The binder can include one or more of sodium lignosulfonate, calcium lignosulfonate, starch, molasses, sodium silicate, or bentonite. In some embodiments, the binder is combined with water (e.g., in a 1:1 ratio) to form a slurry and, in such embodiments, the slurry is combined with the first mixture. The slurry can ensure a more uniform distribution of the chemical constituents within the end product composition.

The method 400 further comprises combining the second mixture and additional lime to form a third mixture (process portion 406). Adding lime in two separate steps, as opposed to one, can help ensure that magnesium oxide has the desired functionality in the composition. For example, by adding the additional lime after an initial dosage of lime has already been added, the magnesium oxide will have been hydrated to form magnesium hydroxide, which will encapsulate and/or protect the prill core. Additionally or alternatively, the magnesium oxide can be pre-hydrated, e.g., by being soaked in water for up to 12 hours to form a slurry. In doing so, the composition, when applied over soil or other medium, can have a longer lasting effect and/or enhanced solubility. The lime and second mixture can be blended at a relatively low rotational speed (e.g., less than 20 revolutions per minute (rpm), 30 rpm, or 40 rpm) for a predetermined amount of time (e.g., 5 minutes or 10 minutes). In some embodiments, water is sprayed over the third mixture to promote granulation.

The method 400 further comprises heating the third mixture to form a product composition (process portion 408). In some embodiments, the third mixture is heated up to at least a predetermined temperature (e.g., 50° C., 55° C., or 60° C.) for a predetermined amount of time (e.g., 12 hours or 24 hours) until the product composition (e.g., a plurality of the particles 100 or the particles 200) is sufficiently dry and/or hardened. As described herein, the product composition can correspond to the particle 200 (FIG. 2) and thus can comprise: (i) 0-25%, 0-20%, or 0-15% calcium carbonate, (ii) 1-10%, 2-10%, or 3-7% of the one or more binders, (iii) 45-75%, 50-70%, or 60-70% lime, (iv) 0-30%, 5-30%, 15-30% magnesium oxide, (v) 0-25%, 0-20%, or 10-20% quicklime, and/or (vi) 1-10%, 2-10%, 5-10% water. Additionally or alternatively, (i) the pH of the particle can be at least 10.0, 10.5, 11.0, 11.5, 12.0, 12.5 or within a range of 10.0-12.5, 11.0-12.5, or 11.5-12.5, (ii) the NV of the particle 100 can be at least 100, 110, 120, 130, 140, 150, or within a range of 100-150, 110-150, or 120-150, (iii) the diameter of the particle 200 (or average diameter of the composition including the particles 200) can be at least 1 mm, 2 mm, 3 mm, 4 mm, 5 mm, 6 mm, or within a range of 1-6 mm, 2-6 mm, or 2-5 mm, and (iv) the crush strength of the particle 200 measured after 28 days (or the average crush strength of the composition including the particles 200 measured after 28 days) can be at least 1 kg, 2 kg, 3 kg, 4 kg, 5 kg, 6 kg, 7 kg or within a range of 1-7 kg, 2-6 kg, or 3-6 kg.

### IV. CONCLUSION

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. The use of “and/or” in a list is to be interpreted as including (a) any single item in the list, (b) all of the items in the list, or (c) any combination of the items in the list. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations, crush strength, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10. As such, a range of “1-10” includes, for example, the values 2, 5.5, and 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

1. A prilled lime composition, comprising:

at least 70% by weight calcium carbonate;

1-10% by weight of a binder;

1-8% by weight calcium hydroxide; and

1-6% water.

2. The composition of any one of the clauses herein, wherein the calcium carbonate comprises 70-95%, 75-90%, 80-90%, or 85-90% by weight of the composition.

3. The composition of any one of the clauses herein, wherein the binder comprises molasses and includes 2-8% or 3-7% by weight of the composition.

4. The composition of any one of the clauses herein, wherein the calcium hydroxide comprises 2-6% or 3-5% by weight of the composition.

5. The composition of any one of the clauses herein, wherein the water comprises 1-5% or 2-5% by weight of the composition.

6. The composition of any one of the clauses herein, further comprising 1-6%, 2-6% or 3-5% magnesium oxide by weight of the composition.

7. The composition of any one of the clauses herein, further comprising a pH of at least 9.5, 10.0, 10.5, 11.0, 11.5, or within a range of 9.5-11.5, 10-11.5, or 10.0-11.0.

8. The composition of any one of the clauses herein, further comprising an acid neutralizing value (NV) of at least 90, 95, 100, 105, 110, 115, or within a range of 90-115, 95-110, or 100-110.

9. The composition of any one of the clauses herein, further comprising an average diameter of at least 1 mm, 2 mm, 3 mm, 4 mm, 5 mm, 6 mm, or within a range of 1-6 mm, 2-6 mm, or 2-5 mm.

10. The composition of any one of the clauses herein, further comprising a crush strength measured after 28 days of at least 1 kg, 2 kg, 3 kg, 4 kg, 5 kg, 6 kg, or within a range of 1-6 kg, 2-6 kg, or 2-5 kg.

11. The composition of any one of the clauses, further comprising a particle size distribution such that (i) no more than 5% of the composition is retained via a 6.7 millimeter (mm) screen, (ii) 80-90% of the composition is retained via a 2.36 mm screen, and (iii) 5-8% of the composition is retained via a 500 micrometer screen.

12. A prilled lime composition, comprising:

1-10% by weight of a binder;

45-75% by weight calcium hydroxide;

0-30% magnesium oxide; and

1-10% water.

13. The composition of any one of the clauses herein, wherein the binder comprises at least one of sodium lignosulfonate, calcium lignosulfonate, starch, molasses, sodium silicate, or bentonite.

14. The composition of any one of the clauses herein, wherein the calcium hydroxide comprises 50-70% or 60-70% by weight of the composition.

15. The composition of any one of the clauses herein, further comprising 1-6%, 2-6% or 3-5% magnesium oxide by weight of the composition.

16. The composition of any one of the clauses herein, wherein the water comprises 2-10% or 5-10% by weight of the composition.

17. The composition of any one of the clauses herein, further comprising 0-25%, 0-20%, or 10-20% by weight calcium oxide.

18. The composition of any one of the clauses herein, further comprising a pH of at least 10.0, 10.5, 11.0, 11.5, 12.0, 12.5 or within a range of 10.0-12.5, 11.0-12.5, or 11.5-12.5.

19. The composition of any one of the clauses herein, further comprising an acid neutralizing value (NV) of at least 100, 110, 120, 130, 140, 150, or within a range of 100-150, 110-150, or 120-150.

20. The composition of any one of the clauses herein, further comprising an average diameter of at least 1 mm, 2 mm, 3 mm, 4 mm, 5 mm, 6 mm, or within a range of 1-6 mm, 2-6 mm, or 2-5 mm.

21. The composition of any one of the clauses herein, further comprising a crush strength measured after 28 days of at least 1 kg, 2 kg, 3 kg, 4 kg, 5 kg, 6 kg, 7 kg or within a range of 1-7 kg, 2-6 kg, or 3-6 kg.

22. The composition of any one of the clauses, further comprising a particle size distribution such that (i) no more than 5% of the composition is retained via a 6.7 millimeter (mm) screen, (ii) 80-90% of the composition is retained via a 2.36 mm screen, and (iii) 5-8% of the composition is retained via a 500 micrometer screen.

23. A method for producing a prilled lime composition, comprising:

combining molasses and water to from a first mixture;

combining the first mixture and calcium carbonate to form a second mixture;

combining the second mixture and lime to form a third mixture; and

heating the third mixture to form a product composition.

24. The method of any one of the clauses herein, wherein the product composition comprises that of any one of the clauses herein.

25. The method of any one of the clauses herein, wherein combining the molasses and the water comprises combining the molasses and the water in a 1:1 ratio.

26. The method of any one of the clauses herein, wherein combining the second mixture and the lime comprises blending the third mixture at a rotational speed no more than 30 revolutions per minute.

27. The method of any one of the clauses herein, wherein heating comprises heating the third mixture to at least 50° C. for at least 12 hours.

28. A method for producing a prilled lime composition, comprising:

combining lime and magnesium oxide to from a first mixture;

combining the first mixture and a binder to form a second mixture;

combining the second mixture and additional lime to form a third mixture; and

heating the third mixture to form a product composition.

29. The method of any one of the clauses herein, wherein the product composition comprises that of any one of the clauses herein.

30. The method of any one of the clauses herein, wherein the binder comprises at least one of sodium lignosulfonate, calcium lignosulfonate, starch, molasses, sodium silicate, or bentonite.

31. The method of any one of the clauses herein, wherein the binder comprises a slurry including water and at least one of sodium lignosulfonate, calcium lignosulfonate, starch, molasses, sodium silicate, or bentonite.

32. The method of any one of the clauses herein, wherein the binder comprises a slurry including water and at least one of sodium lignosulfonate, calcium lignosulfonate, starch, molasses, sodium silicate, or bentonite, and wherein the slurry comprises at least 40% by weight water.

33. The method of any one of the clauses herein, wherein combining the lime and the magnesium oxide comprises combining the lime and the magnesium oxide in a 1:1 ratio.

34. The method of any one of the clauses herein, wherein combining the second mixture and the additional lime comprises blending the third mixture at a rotational speed no more than 30 revolutions per minute.

35. The method of any one of the clauses herein, wherein heating comprises heating the third mixture to at least 50° C. for at least 12 hours. I/We claim:

1. A prilled lime composition, comprising:
1-10% by weight of a binder, wherein the binder comprises at least one of sodium lignosulfonate, calcium lignosulfonate, starch, molasses, sodium silicate, or bentonite;
45-75% by weight calcium hydroxide;
no more than 30% magnesium oxide; and
1-10% water.

2. The composition of claim 1, wherein:
the binder comprises molasses,
the magnesium oxide comprises 3-5% by weight of the composition,
the calcium hydroxide comprises 60-70% by weight of the composition, and
the water comprises 5-10% water.

3. The composition of claim 1, wherein the magnesium oxide is part of a slurry and comprises 3-5% by weight of the composition.

4. The composition of claim 1, further comprising 10-20% by weight calcium oxide.

5. The composition of claim 1, further comprising a pH of at least 11.0.

6. The composition of claim 1, further comprising an acid neutralizing value (NV) above 100.

7. The composition of claim 1, further comprising an average diameter of at least 2 millimeters (mm).

8. The composition of claim 1, further comprising a crush strength, measured after 28 days, of at least 3 kg.

9. The composition of claim 1, further comprising a particle size distribution such that (i) no more than 5% of the composition is retained via a 6.7 millimeter (mm) screen, (ii) 80-90% of the composition is retained via a 2.36 mm screen, and (iii) 5-8% of the composition is retained via a 500 micrometer screen.

10. The composition of claim 1, further comprising an abrasion resistance of no more than 9.0%.

11. A prilled lime composition, comprising:
at least 70% by weight calcium carbonate;
1-10% by weight of a binder;
1-8% by weight calcium hydroxide and/or magnesium oxide; and
1-6% water.

12. The composition of claim 11, wherein the binder comprises molasses and is 2-8% by weight of the composition.

13. The composition of 12, wherein:
the calcium carbonate comprises 75-90% by weight of the composition, the calcium hydroxide comprises 2-6% by weight of the composition, the water comprises 2-5% by weight of the composition.

14. The composition of claim 11, wherein the binder comprises molasses, the composition comprising 2-6% magnesium oxide by weight of the composition.

15. The composition of claim 11, further comprising a pH of at least 9.0.

16. The composition of claim 11, further comprising an acid neutralizing value (NV) of at least 95.

17. The composition of claim 11, further comprising an average diameter of 2-5 mm.

18. The composition of claim 11, further comprising a crush strength, measured after 28 days, of 2-6 kg.

19. The composition of claim 11, further comprising an abrasion resistance of no more than 9.0%.

20. A method for producing a prilled lime composition, comprising:
combining lime and magnesium oxide to from a first mixture;
combining the first mixture and a binder to form a second mixture, wherein the binder comprises at least one of sodium lignosulfonate, calcium lignosulfonate, starch, molasses, sodium silicate, or bentonite;
combining the second mixture and additional lime to form a third mixture; and
heating the third mixture to form a product composition.

21. The method of claim 20, wherein the binder is a slurry and comprises at least 40% by weight water, the method further comprising, prior to combining the first mixture and the binder, pre-hydrating the binder in water for at least 4 hours to form the slurry.

22. The method of claim 20, wherein combining the lime and the magnesium oxide comprises combining the lime and the magnesium oxide in a 1:1 ratio.

23. The method of claim 20, wherein combining the second mixture and the additional lime comprises blending the third mixture at a rotational speed no more than 30 revolutions per minute.

24. The method of claim 20, wherein heating comprises heating the third mixture to at least 50° C. for at least 12 hours.

25. The method of claim 20, wherein the product composition comprises:
1-10% by weight of the binder;
45-75% by weight calcium hydroxide;
no more than 30% magnesium oxide; and
1-10% water.

26. A method for producing a prilled lime composition, comprising:
combining molasses and water to from a first mixture;
combining the first mixture and calcium carbonate to form a second mixture;
combining the second mixture and lime to form a third mixture; and
heating the third mixture to form a product composition.

27. The method of claim 26, wherein the product composition comprises:
at least 70% by weight calcium carbonate;
1-10% by weight of molasses;
1-7% by weight calcium hydroxide; and
1-6% water.

28. The method of claim 26, wherein combining the molasses and the water comprises combining the molasses and the water in a 1:1 ratio.

29. The method of claim 26, wherein combining the second mixture and the lime comprises blending the third mixture at a rotational speed no more than 30 revolutions per minute.

30. The method of claim 26, wherein heating comprises heating the third mixture to at least 50° C. for at least 12 hours.
